(19) United States
(12) Patent Application Publication
(10) Pub. No.: US 2019/0015289 A1
(43) Pub. Date: Jan. 17, 2019

(54) TREATMENT APPARATUS

(71) Applicant: Swellaway Ltd., Lymm (GB)

(72) Inventors: James GRIMOLDBY, St. Asaph (GB); Troy BAKER, St. Asaph (GB); Wyn JONES, St. Asaph (GB)

(21) Appl. No.: 16/036,465

(22) Filed: Jul. 16, 2018

(30) Foreign Application Priority Data
Jul. 17, 2017 (GB) 1711466.1

(51) Int. Cl. A61H 9/00

(52) U.S. Cl. CPC A61H 9/0078; A61H 2201/5007; A61H 2201/0285; A61H 2201/1642; A61H 2201/5043; A61H 2201/0214; A61H 2201/165; A61H 2201/5071; A61H 2201/5082; A61H 2201/0207

(57) ABSTRACT

A treatment apparatus for applying combinations of thermal and compressive treatment programmes to a human or animal body comprises a brace 1110 which itself comprises first and second brace portions 1120, 1130 connected by webbing/strapping 1140. The strapping 1140 comprises first and second straps 1150, 1160, each of which engages both of the brace portions 1120, 1130 via a loop 1170a on one of the brace portions and is held by an anchor 1170b on the other brace portion. The brace portions each comprise a rigid outer shell 1180 of moulded plastics material, and each includes a mounting socket 1190 for detachably mounting a thermal treatment unit (not shown). The mounting sockets 1190 include apertures 200 that extend through the brace portions to the patient facing side, so as to present an active face of the treatment unit to the treatment site.

The present invention relates to a treatment apparatus for treating tissues of a human or animal and is concerned particularly with a treatment apparatus for applying combinations of heating, cooling and/or pressure to a patient.

It is known that the healing of certain types of tissue injuries in humans and animals can be expedited by the application of thermal processes, such as heating or cooling, as well as pressure, in various combinations and PROGRAMs. Historically this has been achieved manually, such as by the application of hot wraps, or ice packs and tightly wound dressings. More recently, apparatus has been proposed for the purpose, typically utilizing thermoelectric modules, such as Peltier cells, and sometimes inflatable wraps or harnesses for mounting the thermoelectric module.

Many such prior devices have been found to be unreliable, ineffective or inefficient. Part of the reason lies in the difficulty in accurately delivering the thermal effect to the tissue site in question. The thermoelectric modules often have only a small active surface area, which means that the effect is highly focused. If the unit is not optimally positioned with respect to the injury, the treatment may be ineffective.

Some previously considered apparatus has sought to broaden the effective area of the thermoelectric unit by placing a large conductive pad over the active surface of the unit. However, this may merely reduce the efficiency of the apparatus.

Problems also arise if the positioning of the thermal unit changes, either because it is not securely mounted on the patient, or else because the wearer removes it and reapplies it incorrectly.

Embodiments of the present invention aim to provide a treatment apparatus in which the abovementioned problems are at least partly addressed.

The present invention is defined in the attached independent claims, to which reference should now be made. Further, preferred features may be found in the sub-claims appended thereto.

According to one aspect of the present invention, there is provided treatment apparatus for providing a thermal treatment to a human or animal body, the apparatus comprising at least one thermal treatment unit and a brace for positioning the treatment unit with respect to the body, wherein the brace comprises at least one brace portion arranged in use to mount the at least one treatment unit in close proximity to a treatment site on the body.

The brace may comprise first and second brace portions, preferably connected by webbing, which webbing is preferably adjustable.

Preferably, each of the first and second brace portions is arranged in use to mount a treatment unit.

In a preferred arrangement, the adjustable webbing comprises two straps, which connect the first and second brace portions, and which straps are preferably independently adjustable. The straps are preferably adjustable by the use of adjustment members. The adjustment members are preferably arranged in use to maintain an effective length of the straps and/or a position of the straps in relation to the brace portions. At least one of the straps may include a fastener for releasably fastening together the strap to the brace portion. Preferably, the fastener is operable independently of the adjustment member.

The brace preferably comprises an expandable portion for applying pressure to a treatment site in use and/or for maintaining the treatment unit in an optimum position with respect to the treatment site.

At least one of the brace portions preferably includes a rigid portion, such as a shell member, arranged in use for the expandable portion to bear against so as to exert pressure on the treatment site.

Preferably each of the first and second brace portions comprises an expandable portion.

The apparatus preferably includes a pressure generator for expanding the or each expandable portion. The pressure generator may comprise a compressor or a pump, for example. Preferably the pressure generator supplies fluid, more preferably air, under pressure to the or each expandable portion. Preferably a single pressure generator is arranged in use to supply pressurized fluid to each of two expandable portions. The single pressure generator is preferably arranged in use to supply pressurized fluid to the two expandable portions via a single supply tube, which may comprise a junction.

The apparatus preferably includes an electronic controller, which may comprise a microprocessor. The controller is preferably arranged in use to control the thermal action of the treatment unit and/or the pressure generator. In a preferred arrangement the controller is programmable and comprises a storage means, such as an electronic memory, for storing one or more treatment programs, which may include combinations of heat and/or cool and/or pressure treatment of the treatment site.

The brace portion may comprise a mounting portion for mounting a treatment unit. The mounting portion may include a socket for receiving, preferably releasably receiving, a treatment unit. The mounting portion may be pivotably/hingedly connected to the brace portion.

In one preferred arrangement, the mounting portion is resiliently biased away from the brace portion so that, in use, the mounting portion, and any treatment portion mounted thereon, is urged towards a treatment site.

Preferably the mounting portion is arranged to engage with the expandable portion. In a preferred arrangement, the mounting portion is configured for engagement with the expandable portion so that the mounting portion moves, preferably pivotably/hingedly with respect to the brace portion when the expandable portion expands, contracts, inflates or deflates.

The mounting portion preferably has a tab or lip or flange part for engagement with a pouch or flap or fold part of the expandable portion for this purpose.

Preferably the mounting portion is arranged to move with respect to the brace portion, more preferably pivotally or hingedly when the expandable portion expands, so that a treatment module mounted on the mounting portion is urged towards a treatment site.

According to a further aspect of the present invention, there is provided a method of providing a thermal treatment to a human or animal body, the method comprising positioning one or more thermal treatment units with respect to the body using a brace and mounting at least one of the treatment units on the brace in close proximity to a treatment site on the body.

The method may comprise independently adjusting two straps forming webbing connecting first and second brace portions, using adjustment members.

The method preferably includes applying pressure to the treatment site, and/or maintaining the treatment unit in an optimum position with respect to the treatment site, using one or more expandable portions.

In a preferred arrangement, the method comprises urging one or more treatment modules towards a treatment site by expanding one or more expandable portions.

The method preferably includes programming a controller to control the thermal action of the treatment unit and/or the pressure generator.

In a further aspect, the invention provides a computer program product on a computer readable medium, comprising instructions that, when executed by a computer, cause the computer to perform a method of providing a thermal treatment to a human or animal body, the method being in accordance with any statement herein.

The invention also comprises a program for causing a device to perform a method of providing a thermal treatment to a human or animal body, the method being in accordance with any statement herein.

The invention may include any combination of the features or limitations referred to herein, except such a combination of features as are mutually exclusive, or mutually inconsistent.

A preferred embodiment of the present invention will now be described, by way of example only, with reference to the accompanying diagrammatic drawings, in which:

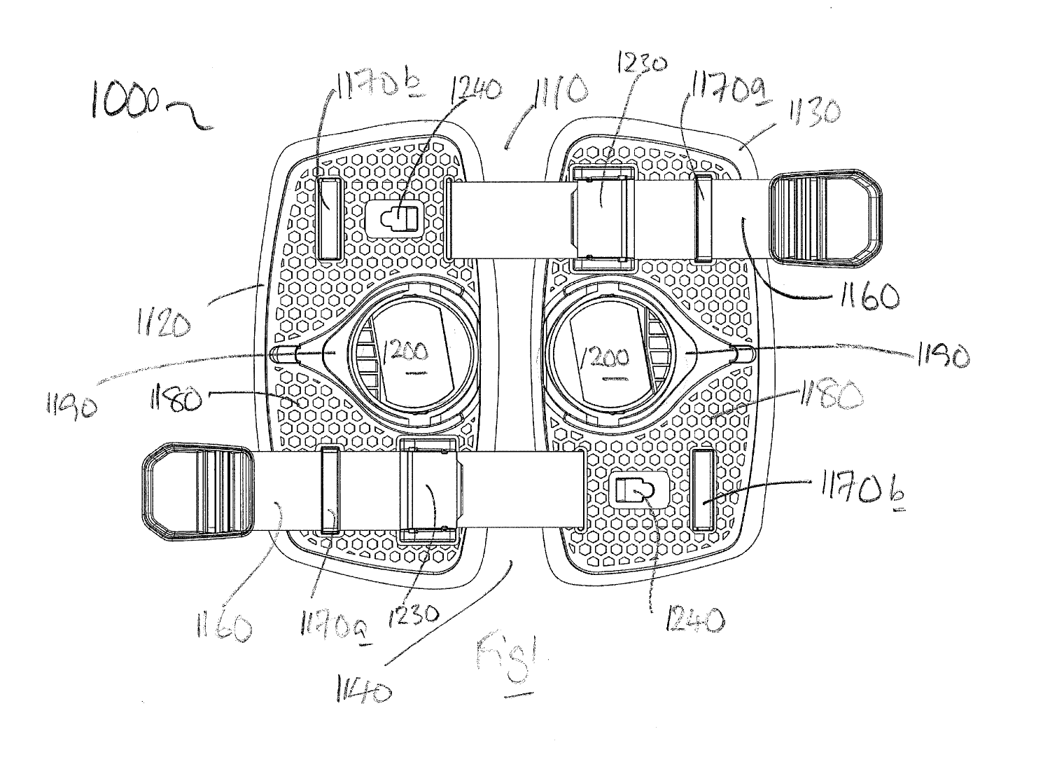

FIG. 1 shows in schematic plan view a treatment apparatus according to an embodiment of the present invention;

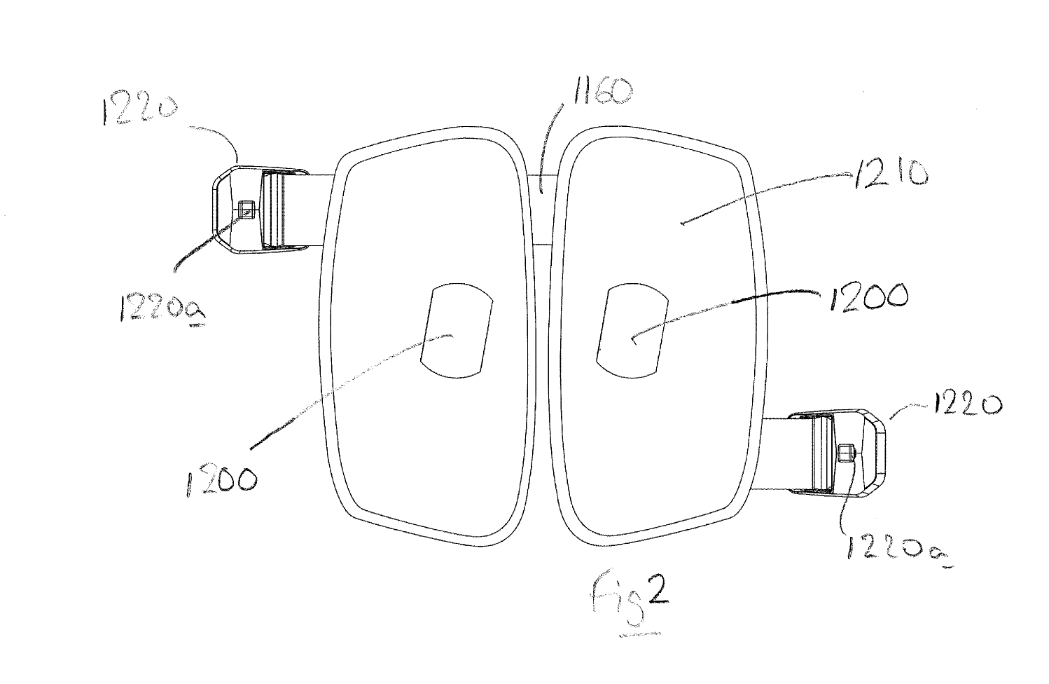

FIG. 2 is a view from below of the apparatus of FIG. 1;

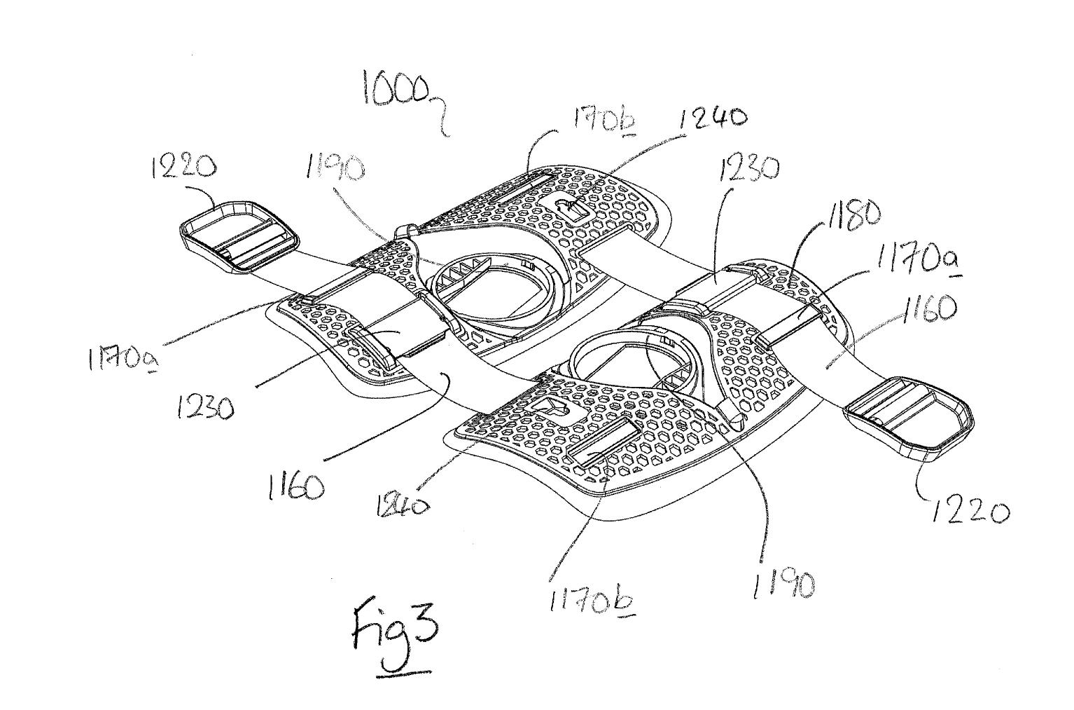

FIG. 3 is a perspective view of the apparatus of FIGS. 1 and 2, with treatment units removed;

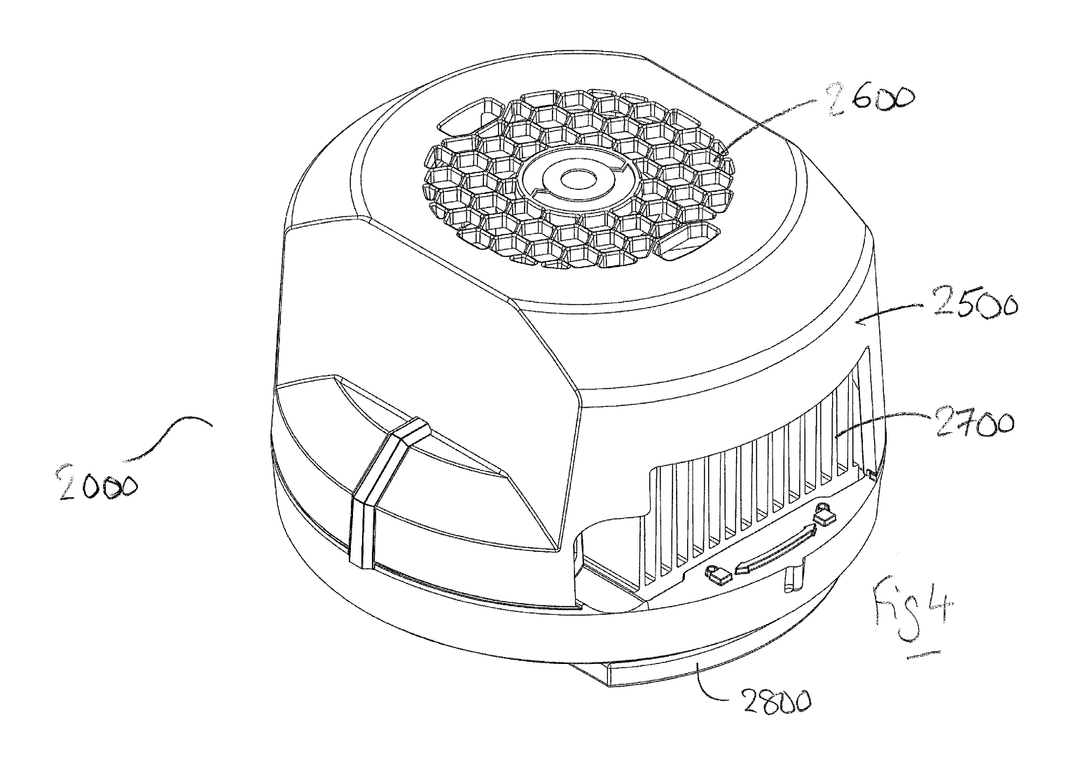

FIG. 4 is a schematic perspective view of a treatment unit;

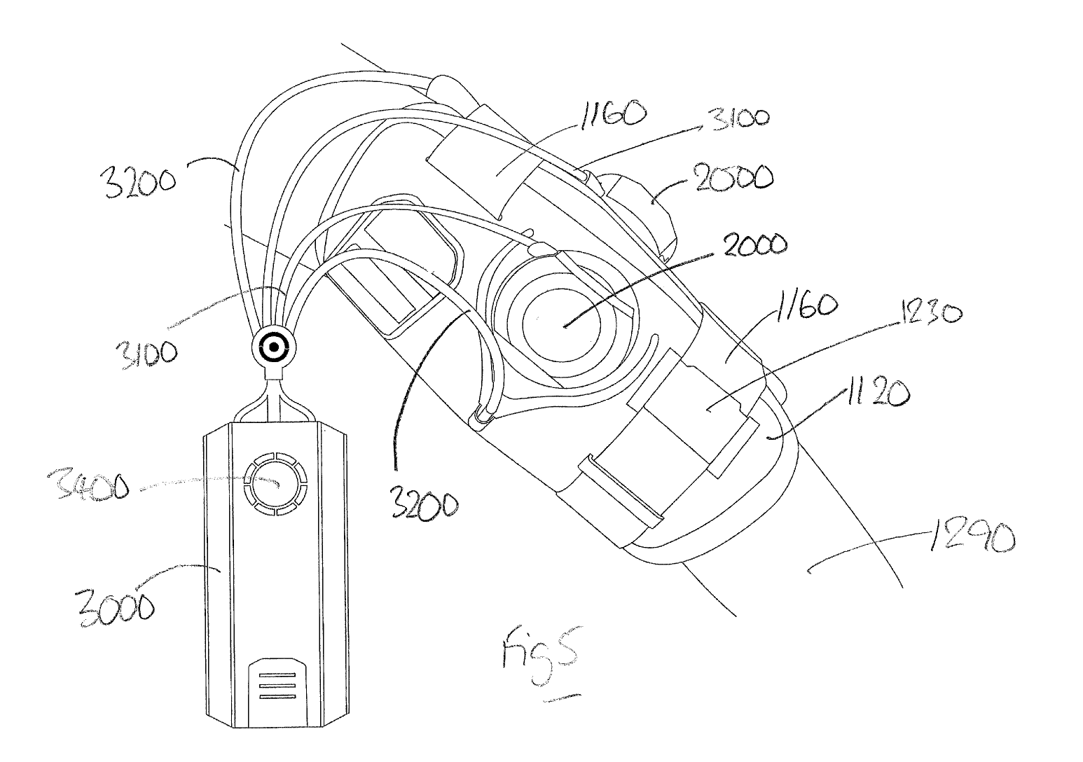

FIG. 5 shows the apparatus in use secured to a limb of a user;

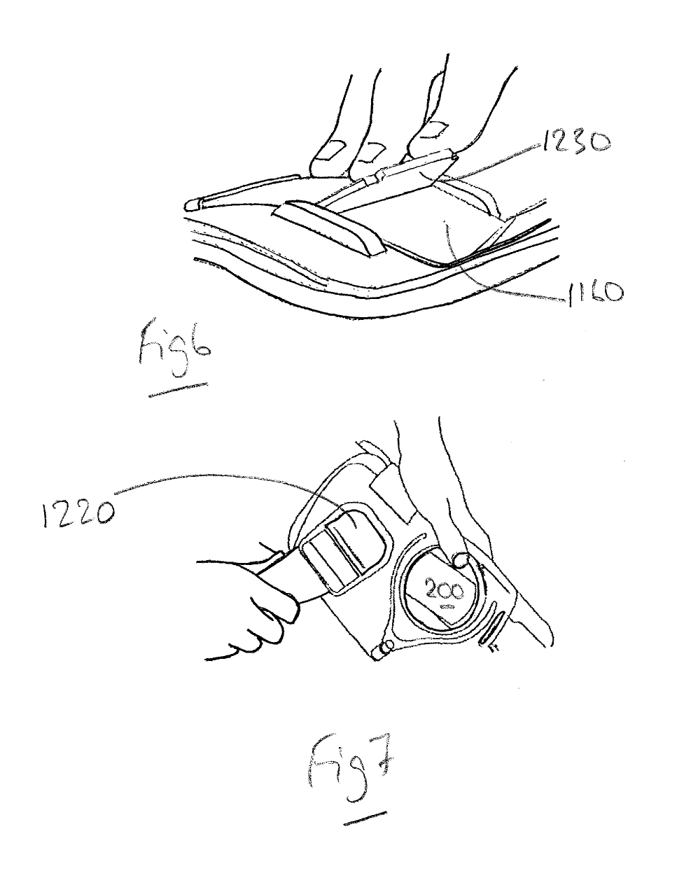

FIG. 6 shows a user adjusting straps of the apparatus;

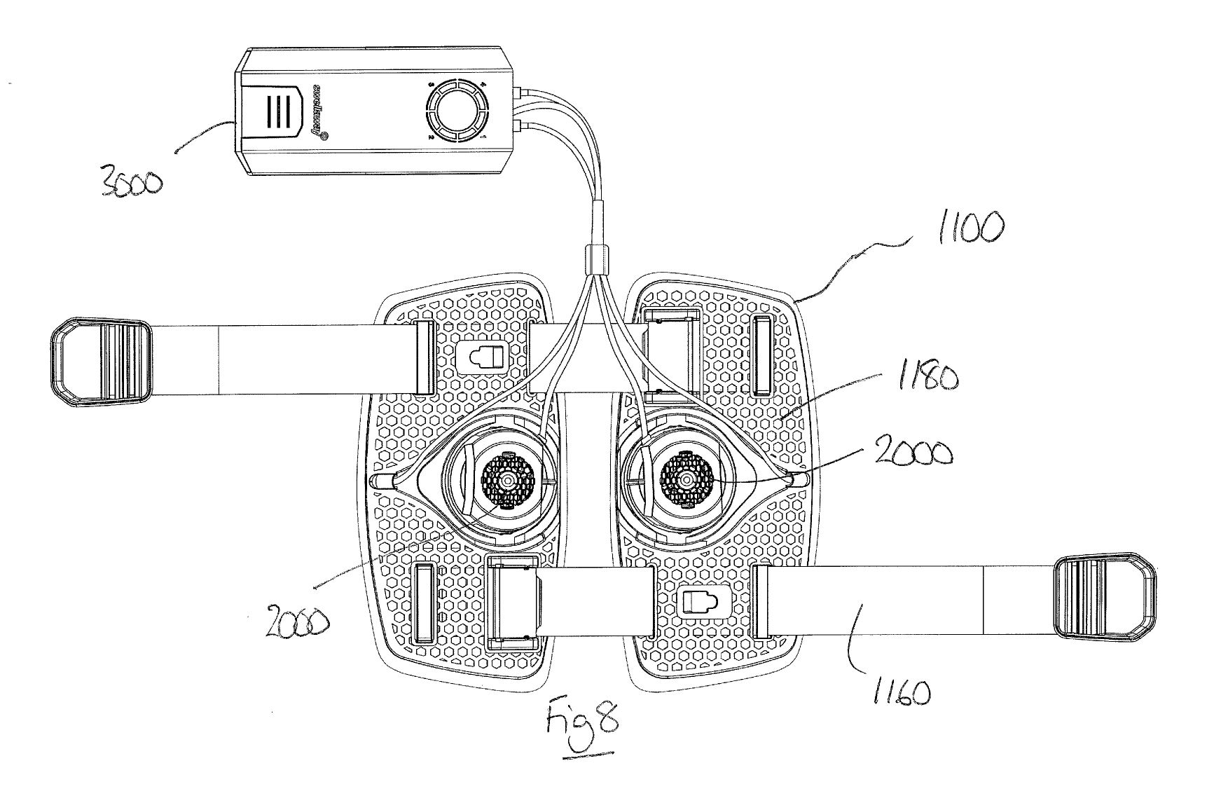

FIG. 7 shows a user securing an adjusted strap;

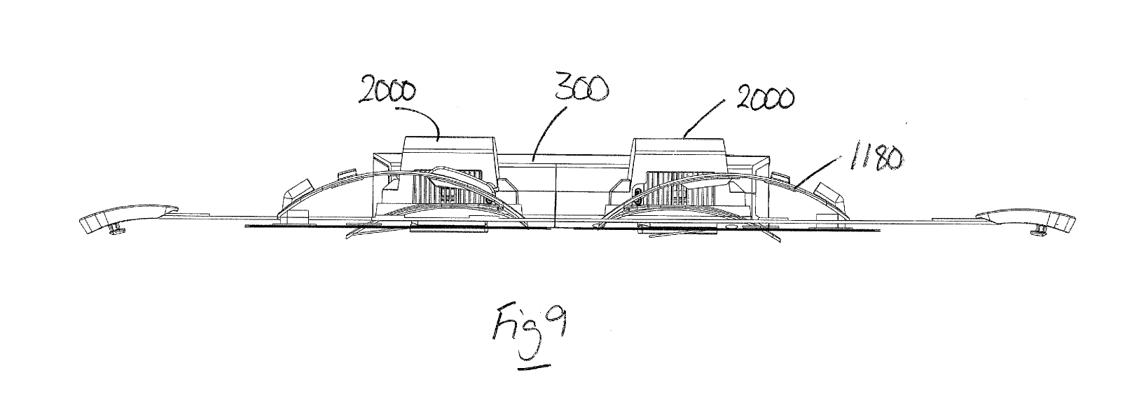

FIG. 8 shows, in schematic plan view, an alternative embodiment of treatment apparatus in accordance with the present invention, with additional functionality;

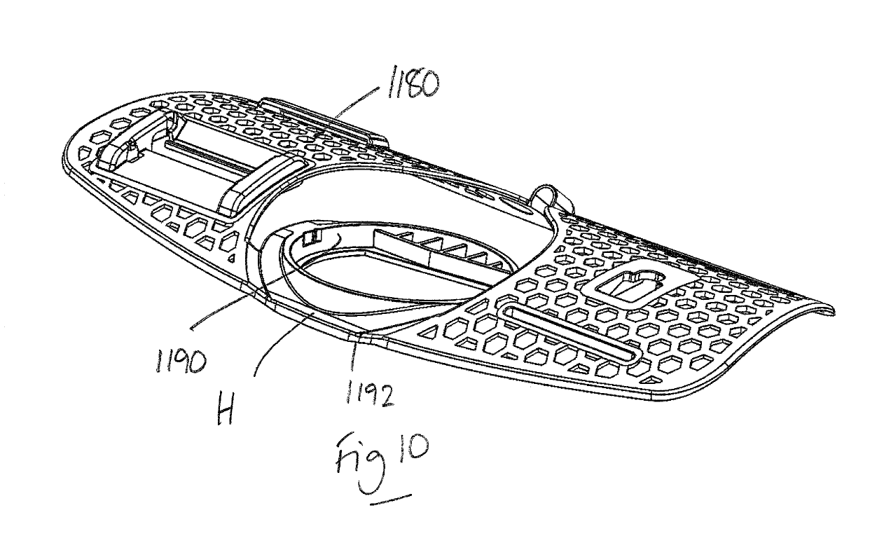

FIG. 9 shows the apparatus of FIG. 8 in side view;

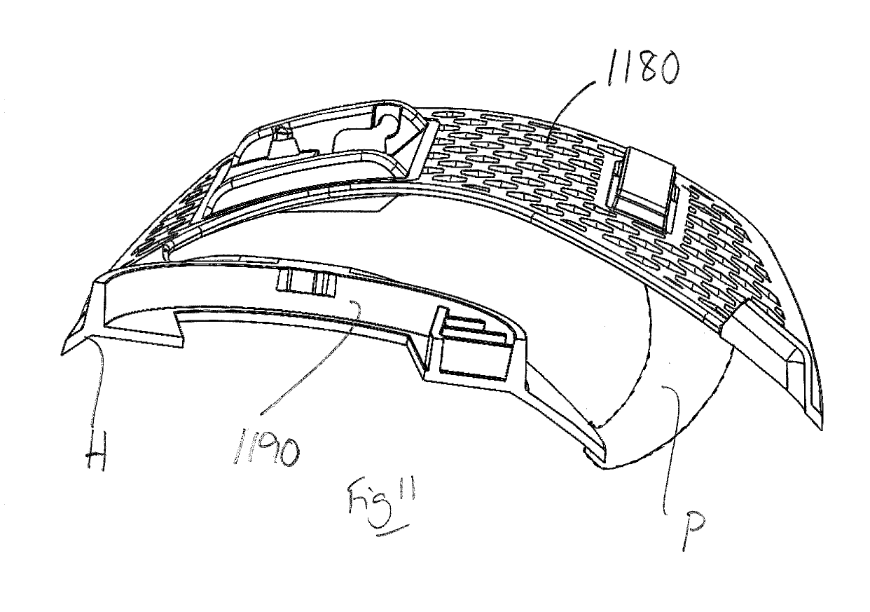

FIG. 10 shows, in schematic perspective view, a part of a brace portion of the apparatus of FIGS. 8 and 9;

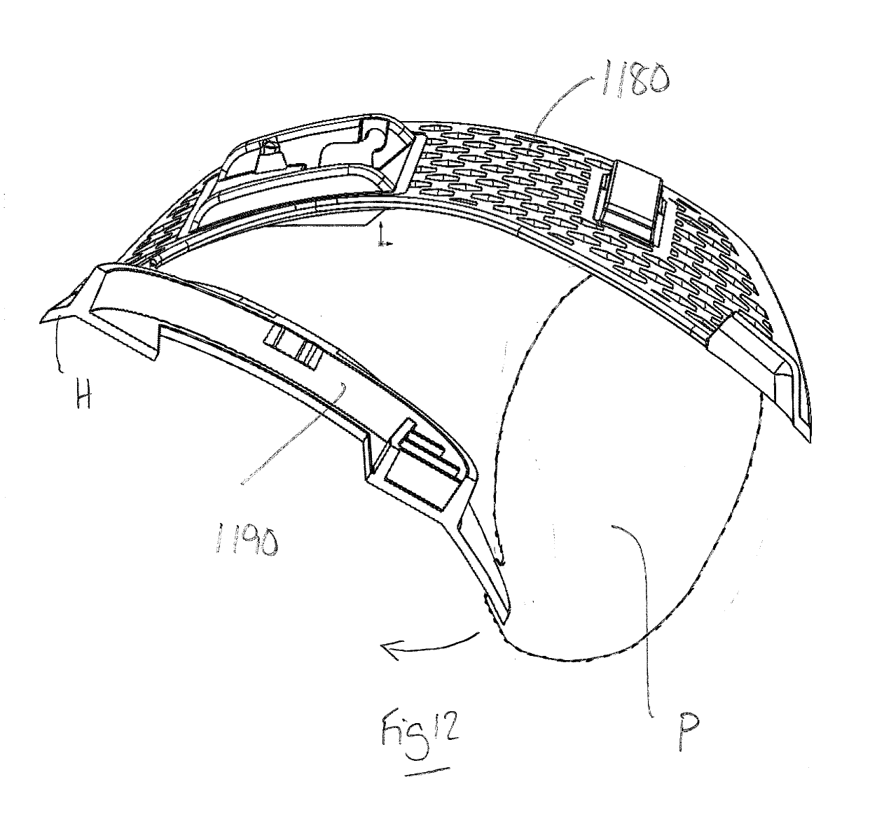

FIG. 11 shows, in schematic cutaway view, the brace portion of FIG. 10 in a first configuration;

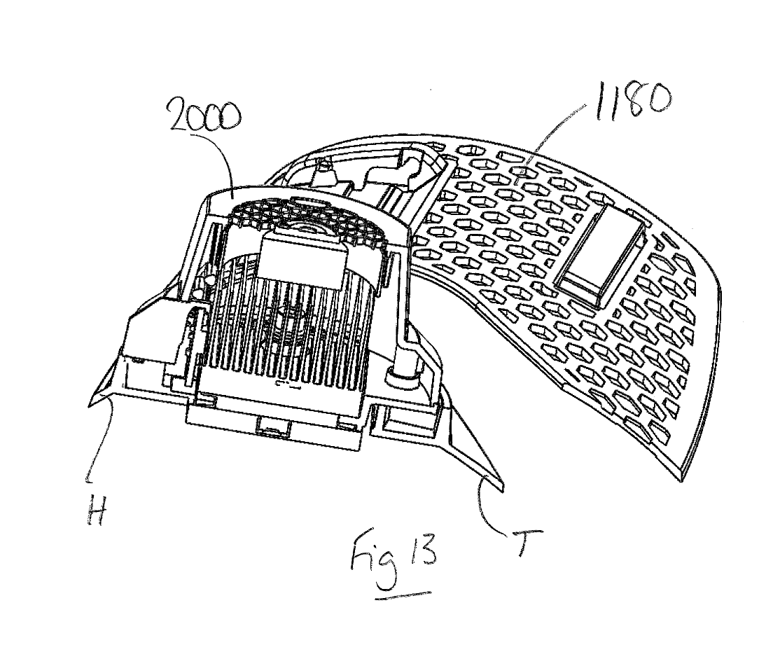

FIG. 12 shows the brace portion of FIG. 11 in a second configuration;

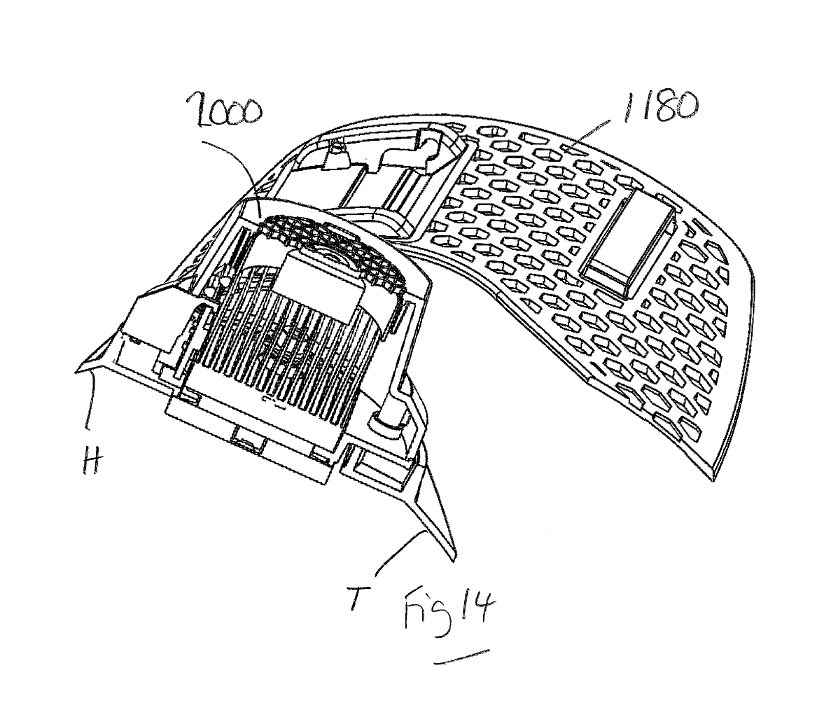

FIG. 13 shows the brace portion of FIG. 11 with a treatment module attached;

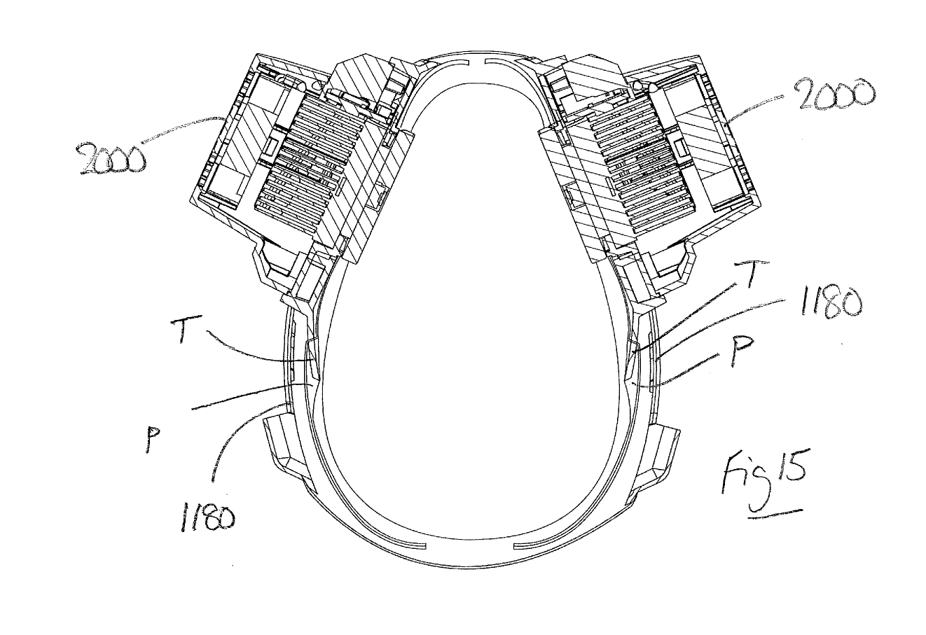

FIG. 14 shows the brace portion of FIG. 12 with a treatment module attached;

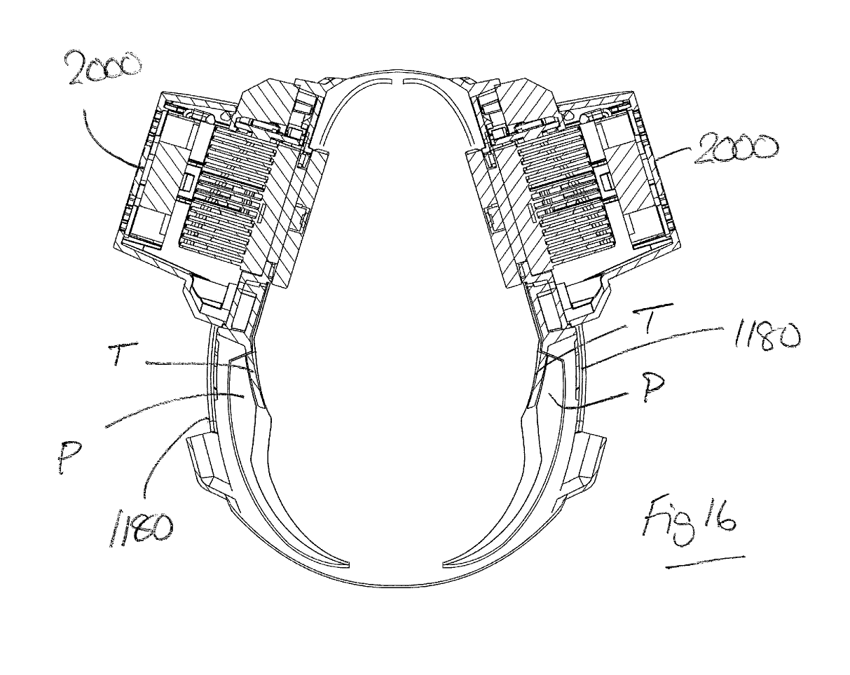

FIG. 15 shows the treatment apparatus of FIG. 8 in an operative position, and in a first configuration; and

FIG. 16 shows the treatment apparatus of FIG. 8 in an operative position, and in a second configuration.

Turning to FIGS. 1 to 3, these show generally at 1000 a treatment apparatus for applying combinations of thermal and compressive treatment programmes to a human or animal body, in accordance with an embodiment of the present invention.

The apparatus 1000 comprises a brace 1110 which itself comprises first and second brace portions 1120, 1130 connected by webbing/strapping 1140. The strapping 1140 comprises first and second straps 1150, 1160, each of which engages both of the brace portions 1120, 1130 via a loop 1170a on one of the brace portions and is held by an anchor 1170b on the other brace portion. The brace portions each comprise a rigid outer shell 1180 of moulded plastics material, and each includes a mounting socket 1190 for detachably mounting a thermal treatment unit (not shown), which will be described in detail below.

The mounting sockets 1190 include apertures 200 (FIG. 2) that extend through the brace portions to the patient facing side, so as to present an active face of the treatment unit to the treatment site.

The brace portions in this example are intended for the treatment of a human leg and are generally trapezoidal in plan. Other shapes and dimensions are possible, depending upon the patient and the treatment site.

The brace portions have a sandwich structure. The shell 1180 is on an outer side, which in faces away from the patient. On the inner side is a soft patient-facing layer 1210 (FIG. 2) of elastic, polymeric fibre. Between these two is an expandable pouch (not shown) that can be inflated to apply pressure to the treatment site.

The straps 1160 are fully, and independently adjustable using buckles 1220 and friction adjusters 1230 that grip the strap and maintain its adjusted length. The buckles each comprise a keying member 1220a (FIG. 2) that is arranged to engage and fasten to a lock portion 1240 on the outer surface of the brace portion, after the strap is wrapped around a limb of a patient (not shown in FIGS. 1 and 2).

Turning now to FIG. 4, this shows a thermal treatment unit 2000 for use with the apparatus. The unit 2000 comprises a housing 2500 of moulded plastics that includes an electric fan 2600 and a heat sink 2700. At a lowermost region the unit includes a Peltier cell (not shown) for producing a heating or cooling effect, and a conductive pad 2800 for applying the thermal effect to the patient. The housing 2500 includes locking profile features (not shown) to allow it to engage with the socket 1180 on the brace portion in a bayonet-type engagement. In doing so, the pad 2800 is presented through the aperture 1200 in the brace portion so that it can contact the treatment site.

In use, once the treatment unit is connected for electrical power, an active (patient-facing) face of the Peltier cell begins to heat up or cool down, according to the polarity of the applied voltage. The fan 2600 draws ambient air over the heat sink 2700, and this then cools or warms a non-active (non-patient-facing) side of the Peltier, so as to maximize its efficiency.

FIG. 5 shows the apparatus in use, attached to a leg L of a patient. The brace has been secured to the patient's leg using the straps 1160 as described above, so that treatment units 2000 are positioned either side of a designated treatment site. A controller 3000 is connected to the brace to provide electrical power for treatment units 2000, and also to supply pressure to the expandable pouch portions within the brace portions 1120 from a compressor (not shown).

Power cables 3100 supply electrical power to the units 2000, and pressurized air is supplied to the expandable pouch portions in the interior of the brace portions via tubes 3200.

The controller 3000 includes a rechargeable power source 3300, which is detachable, a processor (not shown), including a memory, and has a display/interface 3400. A user, or a clinician, is able to determine a PROGRAM of treatment that may include the application of one or more timed cycles of heating, cooling and enhanced pressure to the treatment site. The processor controls the magnitude and polarity of the voltage applied to each of the Peltier devices and the operation of the fans. Temperature sensors in the treatment units, and pressure sensors in the brace portions or in the controller itself provide the controller with feedback, so that the treatment parameters of temperature and pressure can be maintained, and so that excessive or unsafe temperatures and pressures can be avoided.

The user or clinician may interact with the controller 3000 via the display/interface 3400 or else may connect the controller to another device, such as a computer (not shown), wirelessly or via a cable, to install treatment PROGRAMs.

Turning to FIGS. 6 and 7, these show how the straps 1160 can be adjusted so that the treatment units are positioned precisely in relation to the designated treatment site and, just as importantly, retained securely in that position.

FIG. 6 shows how the length of the straps may be adjusted. The strap is fed through the friction adjuster 1230 which has a pivotable locking tab 1230a that can be pressed to grip the strap 1160 securely, effectively determining its operational length. Each of the two straps is adjusted in this way, for example under the guidance of a clinician, to ensure that the treatment units are correctly positioned.

The straps are then passed around the limb of the user and the buckles are then secured to the brace portions as shown in FIG. 7, by engaging the keying members with the corresponding locking portions on the outward facing surfaces of the brace portions to fasten them in position.

The skin of the user may be protected using a disposable wrap (not shown) that can be placed over the skin prior to attaching the apparatus. The conductive pads of the treatment units may be covered in disposable treatment pad (not shown), in the interests of comfort and hygiene.

The apparatus described above allows for the precise placement of thermal treatment units with respect to an intended treatment site, due to the adjustability of the straps and hence the juxtaposition of the brace portions, thus optimising the efficiency and efficacy of the apparatus. Furthermore, the ability to lock the lengths of the straps using the friction adjusters, before independently engaging the buckles, means that a user can take off the apparatus after a cycle of treatment, and when he or she wears again for the next cycle, the treatment units will still be correctly positioned. Any minor adjustment that is needed, for example in response to a reduction in swelling of tissues being treated, can be automatically made by the controller, upon sensing the pressure within the brace.

Turning to FIGS. 8 and 9, these show an alternative embodiment of treatment apparatus, in accordance with the present invention. This embodiment has all of the features of the previously described one, plus some additional functionality as will be described. Accordingly, some of the description of the common features will be omitted.

FIGS. 8 and 9 show the treatment apparatus including the brace 1100 in plan and side views, respectively, with treatment modules 2000 installed on the brace, and the controller 3000 connected for use, as previously described.

In this embodiment, the mounting sockets/portions 1190 are connected to the brace portions 1180 by hinges/pivots as will be described below.

FIG. 10 is a perspective view of one of the brace portions 1180 separate from the rest of the apparatus. The mounting portion 1190 is connected at a proximal edge 1192 to the rigid shell 1180 by a hinge H, which allows the socket 1190 to move pivotally on the shell. The socket portion 1190 can be resiliently biased in the position shown in FIG. 10, in which it is pivoted downwardly away from the shell. In use this would correspond to a direction towards a treatment site, so that the treatment module (not shown in this drawing) would be urged into closer contact with the treatment site.

FIG. 11 shows in part cutaway view a preferred arrangement for the hinged mounting portion 1190, in which at a distal end of the socket 1194 a tab T is located in a flap of the expandable pouch portion P (shown here schematically in broken lines) beneath the shell 1180.

FIG. 12 is the same view as FIG. 12 but shows the result of expanding the pouch P under fluid pumped from the controller 3000 (not shown). Expansion of pouch P urges the hinged mounting socket 1190 to pivot further with respect to the brace portion 1180.

FIGS. 13 and 14 show the effect of this on a treatment unit 2000 mounted on the socket 1190. FIG. 13 shows the neutral position of the module and FIG. 14 the fully biased position of the module when the pouch (omitted from these drawings) is respectively relaxed and fully inflated.

FIGS. 15 and 16 show the full apparatus 1000, with both brace portions 118, each bearing a treatment unit 2000. The apparatus is folded, as though around a leg (not shown) of a user, so that each of the treatment units faces a different treatment site. In FIG. 15 the expandable pouch portions P are relaxed (uninflated), whereas in FIG. 16 they are inflated, causing the operative face of the treatment units to pivot closer to the treatment sites Snot shown).

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A treatment apparatus for providing a thermal treatment to a human or animal body, the apparatus comprising at least one thermal treatment unit and a brace for positioning the treatment unit with respect to the body, wherein the brace comprises at least one brace portion arranged in use to mount the treatment unit in close proximity to a treatment site on the body.

2. Apparatus according to claim 1, wherein the brace comprises first and second brace portions.

3. Apparatus according to claim 2, wherein the brace portions are connected by adjustable webbing.

4. Apparatus according to claim 2, wherein each of the first and second brace portions is arranged in use to mount a treatment unit.

5. Apparatus according to claim 3, wherein the adjustable webbing comprises two straps, which connect the first and second brace portions.

6. Apparatus according to claim 5, wherein the straps are independently adjustable.

7. Apparatus according to claim 5, wherein the straps are adjustable by the use of adjustment members.

8. Apparatus according to claim 7, wherein the adjustment members are arranged in use to maintain an effective length of the straps and/or a position of the straps in relation to the brace portions.

9. Apparatus according to claim 5, wherein at least one of the straps includes a fastener for releasably fastening together the strap to the brace portion.

10. Apparatus according to claim 9, wherein the fastener is operable independently of the adjustment member.

11. Apparatus according to claim 1, wherein the brace comprises an expandable portion for applying pressure to a treatment site in use and/or for maintaining the treatment unit in an optimum position with respect to the treatment site.

12. Apparatus according to claim 11, wherein at least one of the brace portions includes a rigid portion, such as a shell member, arranged in use for the expandable portion to bear against so as to exert pressure on the treatment site.

13. Apparatus according to claim 11, wherein each of first and second brace portions comprises an expandable portion.

14. Apparatus according to any of claim 11, wherein the apparatus includes a pressure generator for expanding the or each expandable portion.

15. Apparatus according to claim 14, wherein the pressure generator comprises a compressor or a pump, for example.

16. Apparatus according to claim 14, wherein the pressure generator supplies fluid, more preferably air, under pressure to the or each expandable portion.

17. Apparatus according to claim 14, wherein a single pressure generator is arranged in use to supply pressurized fluid to each of two expandable portions.

18. Apparatus according to claim 17, wherein the single pressure generator is arranged in use to supply pressurized fluid to the two expandable portions via a single supply tube.

19. Apparatus according to claim 1, wherein the apparatus includes an electronic controller, the controller being programmable and comprises a storage means, such as an electronic memory, for storing one or more treatment programs, which may include combinations of heat and/or cool and/or pressure treatment of the treatment site.

18. Apparatus according to claim 1, wherein the brace portion comprises a mounting portion for mounting a treatment unit.

19. Apparatus according to claim 18, wherein the mounting portion includes a socket for a treatment unit.

20. Apparatus according to claim 18, wherein the mounting portion is pivotably/hingedly connected to the brace portion.

21. Apparatus according to claim 18, wherein the mounting portion is resiliently biased away from the brace portion so that, in use, the mounting portion, and any treatment portion mounted thereon, is urged towards a treatment site.

22. Apparatus according to claim 18, wherein the mounting portion is arranged to engage with an expandable portion.

23. Apparatus according to claim 22, wherein the mounting portion is configured for engagement with the expandable portion so that the mounting portion moves with respect to the brace portion when the expandable portion expands, contracts, inflates or deflates.

24. Apparatus according to claim 22, wherein the mounting portion is arranged to move with respect to the brace portion when the expandable portion expands, so that a treatment module mounted on the mounting portion is urged towards a treatment site.

25. A method of providing a thermal treatment to a human or animal body, the method comprising positioning one or more thermal treatment units with respect to the body using a brace and mounting at least one of the treatment units on the brace in close proximity to a treatment site on the body.

26. A method according to claim 25, wherein the method comprises independently adjusting two straps forming webbing connecting two brace portions, using adjustment members.

27. A method according to claim 25, including applying pressure to the treatment site, and/or maintaining the treatment unit in an optimum position with respect to the treatment site, using one or more expandable portions.

28. A method according to claim 25, wherein the method comprises urging one or more treatment modules towards a treatment site by expanding one or more expandable portions.

29. A method according to claim 25, including programming a controller to control the thermal action of the treatment unit and/or the pressure generator.

30. A computer program product on a computer readable medium, comprising instructions that, when executed by a computer, cause the computer to perform a method according to claim 25.
